(19) United States
(12) Patent Application Publication
(10) Pub. No.: US 2025/0252378 A1
(43) Pub. Date: Aug. 7, 2025

(54) AUTOMATED WORK INSTRUCTION GENERATING SYSTEM

(71) Applicant: IC Labs, LLC, Pasadena, CA (US)

(72) Inventors: Christopher McDaniel, Pasadena, CA (US); Brian Faulkner, Pasadena, CA (US); Michael Kakehashi, Pasadena, CA (US); Lynn Phillips, Pasadena, CA (US); John Kleeman, Pasadena, CA (US)

(21) Appl. No.: 19/047,335

(22) Filed: Feb. 6, 2025

Related U.S. Application Data
(60) Provisional application No. 63/550,999, filed on Feb. 7, 2024.

(51) Int. Cl. G06Q 10/0633; G06Q 10/0631; G06V 10/82; G06V 20/52

(52) U.S. Cl. CPC G06Q 10/0633; G06Q 10/063118; G06V 10/82; G06V 20/52

(57) ABSTRACT

Aspects of the present disclosure relate to systems and methods for providing instructions (e.g., work instructions) to employees. Specifically, aspects of the present disclosure relate to a network service that dynamically determines instructions for each employee and provides the determined instructions to the employees while executing their duties. The network service can determine the instructions based on a set of inputs generated from each computing device and sensor data received from a plurality of sensors deployed at the workspace.

This application claims the benefit of U.S. Provisional Patent Application No. 63/550,999, titled “AUTOMATED WORK INSTRUCTION GENERATING SYSTEM” filed on Feb. 7, 2024, which is hereby incorporated by reference in its entirety.

### BACKGROUND

Generally described, business administrators can manage workflow resources to operate the business more efficiently. The workflow resources can generally refer to operational parameters, such as management of tasks executed by humans. Specifically, managing the workflow resources can include providing instructions to each employee to meet its business outcomes. For example, in the extent of premises management and security, a security patrol service provider, such as the business administrator, may develop a patrol strategy for their client and delegate responsibilities to patrol officers in accordance with this strategy. Subsequently, the service provider could manage the patrol officers by providing one or more instructions to each officer during the execution of their duties.

As also generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet). Such software applications can include general communication applications for accessing the network, such as browser applications. Such general communication applications can access functionality provided by network-based services. The software applications can also include custom or specialized software applications configured to implement specific functionality alone or in combination with network-based services.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of a system that includes one or more computing devices, sensors, and a network service provider according to one or more embodiments as disclosed herein;

FIG. 2 is a block diagram of illustrative components of a network service provider according to one or more embodiments as disclosed herein;

FIG. 3 is an illustrative interaction of generating instructions that can be utilized in the aspects of workflow monitoring service in one or more embodiments as disclosed herein; and

FIG. 4 is a flow diagram illustrative of a routine for generating instructions utilizing the network service provider.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without specific details. Furthermore, well-known features may be omitted or simplified in order not to obscure the examples being described.

Generally described, aspects of the present disclosure relate to systems and methods for providing instructions (e.g., work instructions) to employees. Specifically, aspects of the present disclosure relate to a network service that dynamically determines instructions for each employee and provides the determined instructions to the employees while executing their duties. The network service can determine the instructions based on a master plan and sensor data received from a plurality of sensors deployed at the workspace. For example, a security service provider may generate a master plan based on performance metrics, service level agreements (SLAs) associated with individual security patrol contracts. Based on this master plan, one or more patrol officers can be assigned for each patrol shift. In addition, a plurality of sensors, such as motion detection sensors, audio record sensors, cameras, etc., can be deployed in the security patrol areas. In this example, the security service provider can receive the information generated from each sensor and process the received information to generate security patrol instructions in real-time or near real-time. In addition, the security service provider may provide the instructions to each security patrol via wireless communication.

Illustratively, one or more aspects of the present application correspond to implementation in computer networks in which a plurality of computing devices has been configured in a manner that these computing devices exchange information with a network service provider via the computer networks, such as the wireless network. By way of illustrative example, the plurality of computing devices can correspond to electronic devices utilized by employees who are executing their duties. For example, the employee can utilize their computing device to receive instructions from the network service provider and also to provide information, such as any reports, while executing their duty. In some examples, such computing devices can provide their current location information to the network service provider in real time or near real time. In some illustrated examples, the computing device can be configured to implement one or more functionalities to facilitate the employees' performance of their duties. For example, the computing device can be utilized by a security patrol officer, and the officer can utilize the camera functions of the computing device to scan the patrol area. Also, the officer can utilize the communication functions of the computing device to communicate with other patrol officers, supervisors, and the network service provider. These functions can be implemented based on specific applications, and the present disclosure does not limit any type of functionality.

In accordance with one or more implementations, a plurality of sensors or one or more sensors can be deployed within the workspace. These sensors can include any type of information gathering or generating device or component, including but are not limited to. motion sensors, temperature sensors, smoke detectors, humidity sensors, light sensors, noise sensors, occupancy sensors, pressure sensors, etc. The sensors can, in some embodiments, correspond to stand-alone devices or components that are configured (at least in part) specifically to provide information. For example, a stand-alone temperature sensor configured to measure, collect or generative information regarding environmental conditions. In other embodiments, the sensors can correspond to integrated or combination devices that may be utilized to generate sensor data but may have additional or alternative functionality not specifically configured to provide information. For example, a heating unit that may utilize temperature-based controls for operation and that operational information can be processed to generate environmental condition information. The types of the deployed sensors can be determined based on the types of tasks assigned in a workflow. In some illustrative embodiments, each of the plurality of sensors may transmit data (wirelessly or wired) that is received by the network service provider. The network service provider can process the received data by analyzing attributes included in the data. For example, motion sensors, temperature sensors, and noise sensors can be implemented in a defined geographic region (e.g., a security patrol area), and the network service provider can receive data from these sensors in real time. In this example, the network service provider can process the received data and detect any abnormalities. For instance, the network service provider may determine the abnormality by detecting an expected movement or noise at a patrol area during nighttime. After detecting these abnormalities, the network service provider may automatically generate instructions to the duty patrol officers to visually check the patrol area.

In some cases, the network service provider, upon analyzing the sensor data, can provide notification to various entities, such as business operation administrators, managing officers, on-duty employees, and the like. In some examples, the network service provider can automatically determine and apply one or more corrective actions in addition to providing the notifications. For example, in the context of the network service provider used for a security patrol service, the network service provider may detect abnormalities in certain patrol areas by obtaining and analyzing the sensors. In this example, the network service provider may automatically notify the on-duty patrol officer(s), their supervisors, managing officers, a property owner of the security patrol areas, and the like. Additionally, the network service provider automatically identifies and applies correct actions. For example, if the network service provider determines high temperature by receiving data from a temperature sensor, the network service provider may automatically enable a sprinkler and/or contact the fire department. In some cases, the network service provider may determine whether any action was taken regarding the detected abnormalities. For example, if the network service provider detects a high temperature in a patrol area and no action is taken, the network service provider may notify the managing officer(s), headquarters personnel of the security service provider, and the like. The present disclosure does not limit the types of notifications.

In accordance with one or more aspects of the present disclosure, the network service provider can implement one or more machine learned models as part of the processing of information to generate processing results. Illustratively, machine learned models can be configured to generate output in the form of instructions by monitoring data received from the plurality of sensors and/or the computing devices. For example, a machine learned model can be trained to generate instructions for the employees to perform their duties more efficiently. By way of illustration, the machine learned model can incorporate one or more aspects of a large language model (LLM) in which outputs generated can correspond to structured outputs, such as text, images, and a combination thereof. In some examples, the machine learned models can be configured to analyze the data received from the plurality of sensors and detect one or more abnormalities among the data. For example, the machine learned model can determine unexpected noise levels comparing to the occupancy of a security patrol area and generate instructions in accordance with the determination.

In some aspects of the present disclosure, the machine learned model can also receive visual information as inputs. Illustratively, the computing devices utilized by the employees and/or cameras installed within a workspace area can scan the surrounding area and transmit the captured images (e.g., videos) to the network service provider. To process the captured image according to the machine learned model(s), one or more machine learned models may utilize various types of image processing techniques to modify the input data, such as by identifying a region of interest from the captured image associated with one or more objects within the image. In other embodiments, the machine learned models may be optimized in a manner such that regions of interest data from data inputs may also be preferred for processing. For example, if the machine learned model is configured to monitor the security patrol areas by detecting features that indicate a likelihood of abnormalities within the patrol areas, the machine learning model may detect objects in the areas and analyze whether these objects are risk objects. For example, the machine learned model may score risk score for each detected object. Additionally, the machine learned model may further verify its risk score by generating confidence values. In some embodiments, the machine learned model can be continuously trained based on a threshold confidence of example outputs corresponding to the trained model being used to identify the abnormalities within the workspace areas. For example, the training can be based on the ground truth level of the machine learned model.

In general, traditional networks that provide instructions to employees rely on providing instructions via tag scanning (e.g., NFC tag) and/or quick response (QR) code scanning. For instance, an employee, such as a security patrol officer, can use a computing device to scan a tag or QR code. The network service provider embeds relevant instructions associated with these tags and QR codes. As such, scanning the tag or code delivers these embedded instructions to the computing device. However, in these conventional networks, the instructions linked to the tag and QR code are static and cannot be dynamically updated. This limitation can lead to inefficiencies and constraints in carrying out the officer's duties. For example, a security patrol officer might receive a static instruction like checking a particular patrol post. However, if a previous officer already reported a broken window at the base of the building and completed a security check, the current officer would still receive the same instruction to check the same post, potentially leading to a redundant security check. Additionally, when these two officers compile their daily reports, they might include identical information about the first patrol post, leading to redundancy. This can result in management inefficiencies for the security service provider. Moreover, it might be challenging for the security service provider's management to monitor whether the security officer has diligently carried out the instructions.

To address at least a portion of the deficiencies described above, one or more aspects of the present disclosure relate to systems and methods for generating instructions by dynamically adapting to the current environment. Specifically, these systems and methods can generate instructions in real time or near real time in dynamically changing environments by utilizing data generated from computing devices and one or more sensors associated with the work environment. Illustratively, a network service provider can implement a workflow monitoring service. According to one or more embodiments, as disclosed herein, the workflow monitoring service may dynamically generate instructions and provide the generated instructions to each employee.

In various embodiments, the workflow monitoring service can monitor the location of the employees and determine whether the employees are within the physical range of performing their assigned duties. For example, the workflow monitoring service implemented by a security patrol service provider may monitor the location of the security patrol officers and determine whether these officers are within a post associated with their patrol duty. In some examples, the workflow monitoring service can automatically transmit patrol instructions in response to determining that the patrol officers are within a range of their assigned patrol area. For example, the workflow monitoring service may transmit the instructions to the computing device utilized by the individual patrol officer.

In some embodiments, the workflow monitoring service may analyze the workflow related environments in real time or near real time. For example, the workflow monitoring service (e.g., implemented by a security patrol service provider) can receive data from one or more sensors deployed in the physical environment. Illustratively, sensors, such as motion sensors, temperature sensors, smoke detectors, humidity sensors, light sensors, noise sensors, occupancy sensors, pressure sensors, etc., can be deployed within a security patrol area. The workflow monitoring service may identify one or more events that indicate abnormalities of the one or more data received from these sensors. For example, the noise level detected by the noise sensor is higher than the normal range. In these examples, the workflow monitoring service can automatically generate instructions to the corresponding patrol officers and transmit the automatically generated instructions to the officers. In some examples, the workflow monitoring service can be configured to receive from the sensors associated with the current location of the employee. For example, when a patrol officer walks into a certain post, the sensors associated with the post can automatically generate sensor data and transmit to the workflow monitoring service.

In accordance with one or more aspects of the present disclosure, the workflow monitoring service can implement a machine learned model to analyze the data generated by the one or more sensors. For example, the machine learned model may analyze noise captured by the noise sensor and determine whether a patrol officer should be deployed to check the post area associated with the noise. In some embodiments, the machine learned model can be utilized to analyze captured images and generate instructions based on the analyzed results. For example, a patrol officer may scan the surrounding area by utilizing the officer's computing device (e.g., the camera of the computing device) and transmit the scanned images to the workflow monitoring service. The machine learned model may identify one or more objects included in each captured image and generate an output corresponding to a risk score for each object. The risk score output is illustratively a characterization of risk based on the machine learned model training set, reward/penalty model, or a combination thereof. In response to determining that the risk score associated with one or more objects is at or higher than a threshold, the machine learned model may generate an instruction to visually monitor the corresponding area. The machine learned model can also perform retraining its model by using the ground truth level for each anticipated risk score. For example, the machine learned model may verify each risk score by designating with confidence value based on the ground truth level. The machine learned model may perform this retraining continuously. In some cases, the machine learned model may store the images of the identified object or person in the database with the confidence value. Thus, the machine learned model, upon detecting the object or person from the received image, may automatically determine the risk score. The machine learned model can also perform the person's behavior analysis based on the video (e.g., images) captured by the computing device and/or the sensors.

In some cases, the workflow monitoring service can generate dynamic instructions based on the employee's profile. For example, the patrol officers within a post can receive different types of instructions based on each officer's level of experience. For instance, if the patrol officer is a junior officer, the instruction could be “contact a supervisor and report the incident.” If the patrol officer is a senior officer, the instruction could be “go to the incident area and secure the area.” In addition, if the patrol officer is a supervisor, the instruction could be “send two senior officers to the incident area.” In addition, the workflow monitoring service can generate instructions based on the types of incidents. For example, if the incident is related to a weapon found on a floor, the instruction could be “do not touch the found gun, secure the area, and call law enforcement.” Thus, the workflow monitoring service can generate instruction in dynamically changing environments.

Although aspects of the present disclosure will be described with regard to illustrative network components, interactions, and routines, one skilled in the relevant art will appreciate that one or more aspects of the present disclosure may be implemented in accordance with various environments, system architectures, customer computing device architectures, and the like. Similarly, references to specific devices, such as a customer computing device, can be considered to be general references and not intended to provide additional meaning or configurations for individual customer computing devices. Additionally, the examples are intended to be illustrative in nature and should not be construed as limiting.

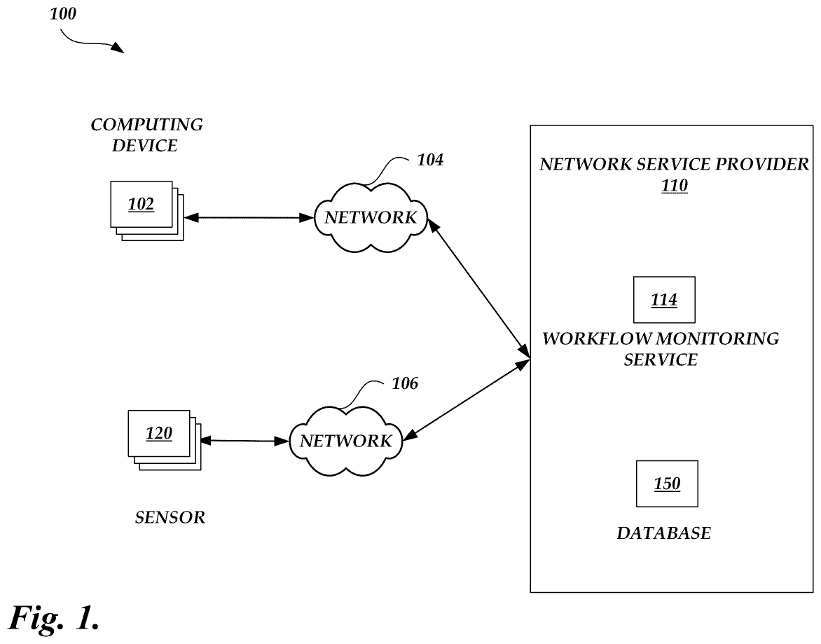

FIG. 1 depicts a block diagram of an embodiment of the system 100. The system 100 can include a network 104, the network connecting a plurality of computing devices 102 and the network service provider 110. The system 100 can also include a network 106, the network connecting a number of sensors 120 and network service provider 110. Illustratively, the various aspects associated with the network service provider 110 can be implemented as one or more components that are associated with one or more functions or services. The components may correspond to software modules implemented or executed by one or more customer computing devices, which may be separate stand-alone customer computing devices. Accordingly, the components of the network service provider 110 should be considered as a logical representation of the service, not requiring any specific implementation on one or more customer computing devices.

Networks 104, 106 as depicted in FIG. 1, can connect the network service provider 110 and the computing devices 102 and the sensors 120, respectively. The networks 104, 106 can comprise any combination of wired and/or wireless networks, such as one or more direct communication channels, local area networks, wide area network, personal area network, and/or the Internet, for example. In some embodiments, the communication between the network service provider 110 and the computing devices 102 and/or the sensors 120 may be performed via a short-range communication protocol, such as Bluetooth, Bluetooth low energy (“BLE”), and/or near field communications (“NFC”).

In some embodiments, the networks 104, 106 may be a private or semi-private network, such as a corporate or university intranet. The networks 104, 106 may include one or more wireless networks, such as a Global System for Mobile Communications (GSM) network, a Code Division Multiple Access (CDMA) network, a Long Term Evolution (LTE) network, or any other type of wireless network. The networks 104, 106 can use protocols and components for communicating via the Internet or any of the other aforementioned types of networks. For example, the protocols used by the networks 104, 106 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In some implementations, the network 104 can include one or more routers (not shown in FIG. 1). The routers can function as a gateway and can be configured to receive signals from nearby computing devices and route the received signals to the network service provider 110. In some examples, the router can transmit signals that include location information of the nearby computing device 102. In some scenarios, the computing devices 102 may continuously send beacon signals to nearby router(s). The beacon signal can be transmitted at regular intervals and contain identification information, such as the location information of the computing device 102. Thus, the network service provider 110 can continuously receive the location information from the computing devices 102.

The types of network 104 and network 106 can be the same type of network or different types of network. These types can be determined based on specific applications, and the present disclosure does not limit these types of networks.

As described in FIG. 1, the network service provider 110 can be communicatively coupled with the computing devices 102 via the network 104. The network service provider 110 can connect any number of computing devices 102. Each computing device 102 can be utilized by an employee and configured to provide work related information. For example, if the network service provider 110 is adapted for the security patrol service provider, the employee can be the patrol officer. In some embodiments, the computing devices 102 can be any computing device such as a desktop, laptop or tablet computer, personal computer, tablet computer, wearable computer, server, personal digital assistant (PDA), hybrid PDA/mobile phone, mobile phone, smartphone, set-top box, voice command device, digital media player, and the like. In some embodiments, the computing devices 102 may execute an application (e.g., a browser, a stand-alone application, etc.) that allows a user (e.g., an employee) to access interactive user interfaces, view images, analyses, or aggregated data, and/or the like as described herein. In various embodiments, users (e.g., employees) may interact with the network service provider via various devices. Such interactions may typically be accomplished via interactive graphical user interfaces or voice commands, however, alternatively, such interactions may be accomplished via command line and/or other means.

In some embodiments, the computing device 102 can include a camera. The camera can be utilized to capture images. For example, a patrol officer may scan the officer's surrounding area. The images of the scanned area can be captured by the camera, and the computing device 102 can transmit the captured images to the network service provider 110. In some examples, the camera can be an external device and connected to the computing device 102.

In certain instances, the computing device 102 can offer a graphical interface equipped with features designed to assist in the performance of an employee's duties. For example, the patrol officer can utilize the graphical interface to report any security related incidents. In addition, the graphical interface can display instructions received from the network service provider 110. The present disclosure does not limit the functionality types of graphical interface, and the types can be determined based on specific applications.

As described in FIG. 1, the network service provider 110 can be communicatively coupled with the sensors 120 via the network 106. The network service provider 110 can connect any number of sensors 120. The present disclosure does not limit the types of sensors, and the types can be determined based on specific applications. For example, the types of sensors utilized for security patrol can include but are not limited to temperature sensors, proximity sensors, light sensors, motion sensors, gas sensors, image sensors, radar sensors, etc.

In some embodiments, any suitable type and number of sensors 120 can be deployed in working areas. For example, each security post can include one or more types of sensors 120, where the types and number of sensors can be determined based on the characteristics of the security post.

The network service provider 110, as shown in FIG. 1, can include a workflow monitoring service 114 and database 150. The workflow monitoring service 114 can be configured to monitor workflows of the individual employee. The workflow can generally refer to an employee's duty. For instance, the workflow of a patrol officer may encompass their shift timing and the specific responsibilities tied to their patrol duties.

In some embodiments, the workflow monitoring service 114 can track the location of the employees. For example, the computing devices 102 utilized by each employee can continuously transmit its location to the workflow monitoring service 114.

In some embodiments, the workflow monitoring service 114 can provide instructions to the employees. The instructions can be work related instructions, and the employees, while executing their job duties, can receive the instructions from the workflow monitoring service 114. In various examples, the workflow monitoring service 114 can generate the instructions by processing data received from the sensors 120. The instructions can be dynamically generated based on the processing result of the sensor data. For example, the workflow monitoring service 114 can continuously receive sensor data generated from a security patrol area that includes a plurality of posts. In this example, the workflow monitoring service 114 may detect any abnormalities from one or more posts, and the workflow monitoring service 114 can generate instructions based on the detected abnormalities and transmit the generated instructions to nearby patrol officers.

In certain embodiments, the workflow monitoring service 114 can provide location-based instructions to each employee. For instance, a patrol officer, while covering an area with multiple security posts, may receive specific instructions upon entering each security post.

In some examples, the workflow monitoring service 114 can receive images (and video clips) that capture the patrol officer's surrounding area. For instance, the patrol officer may be required to periodically scan the surrounding area, either at specified time intervals or upon entering a new post. In addition, the patrol officer can continuously capture images and transmit the captured images to the workflow monitoring service 114 via the network 104. Furthermore, the patrol officer can provide any information, such as incidents, in the form of text, voice, etc.

In various examples, the workflow monitoring service 114 can dynamically generate instructions based on the captured images and/or information received from each employee (e.g., each employee's computing device). The instructions provided by the workflow monitoring service 114 are dynamically generated based on processing results of sensor data and inputs (e.g., captured images and incident report information) received from the computing devices 102. In addition, the workflow monitoring service 114 can generate the instructions based on the level of experience (or hierarchy) of employees. For example, the patrol officers within a post can receive different types of instructions based on each officer's level of experience. For instance, if the patrol officer is a junior officer, the instruction could be “contact a supervisor and report the incident.” If the patrol officer is a senior officer, the instruction could be “go to the incident area and secure the area.” In addition, if the patrol officer is a supervisor, the instruction could be “send two senior officers to the incident area.” In addition, the workflow monitoring service can generate instructions based on the types of incident. For example, if the incident is related to a weapon found on a floor, the instruction could be “do not touch the found gun, secure the area, and call law enforcement.” Thus, the workflow monitoring service can generate instruction in dynamically changing environments.

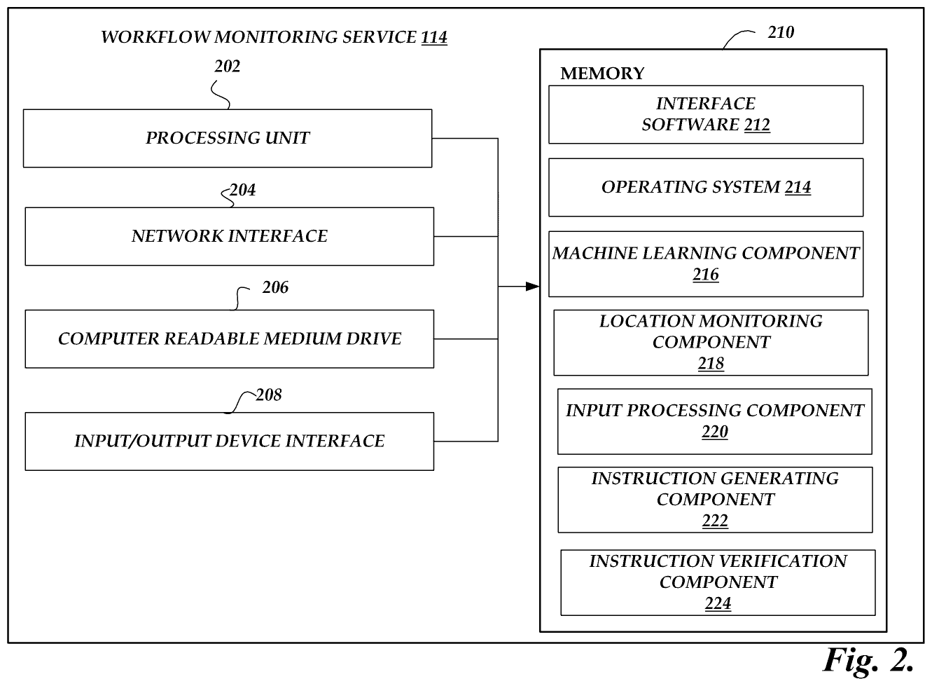

FIG. 2 depicts one embodiment of the architecture of an illustrative workflow monitoring service 114. The workflow monitoring service 114 can be configured to generate instructions. More specifically, the workflow monitoring service 114 can provide guidance to employees in dynamically changing environments by processing a variety of sensor data and employee input data, such as captured images and reports generated by the computing device. The general architecture of the workflow monitoring service 114 depicted in FIG. 2 includes an arrangement of computer hardware and software components that may be used to implement aspects of the present disclosure. As illustrated, the workflow monitoring service 114 includes a processing unit 202, a network interface 204, a computer-readable medium drive 206, and an input/output device interface 208, all of which may communicate with one another by way of a communication bus. The components of the workflow monitoring service 114 may be physical hardware components or implemented in a virtualized environment.

The network interface 204 may provide connectivity to one or more networks, such as the networks 104 and 106 of FIG. 1. The processing unit 202 may thus receive information and instructions from other computing systems or services via a network. The processing unit 202 may also communicate to and from memory 210 and further provide output information for an optional display via the input/output device interface 208. In some embodiments, the workflow monitoring service 114 may include more (or fewer) components than those shown in FIG. 2.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the workflow monitoring service 114. The memory 210 may further include computer program instructions and other information for implementing aspects of the present disclosure. For example, in one embodiment, the memory 210 includes interface software 212 for communicating with other components or services and performing one or more aspects as disclosed herein.

The memory 210 may include a machine learning component 216. The machine learning component 216 can be configured to analyze data and generate dynamic instructions in accordance with one or more embodiments as disclosed herein. In some embodiments, a number of different types of algorithms may be used by the machine learning component 216 to generate the models. For example, certain embodiments herein may use a logistical regression model, decision trees, random forests, convolutional neural networks, deep networks, or others. However, other models are possible, such as a linear regression model, a discrete choice model, or a generalized linear model. The machine learning algorithms can be configured to adaptively develop and update the models over time based on new input received by the machine learning component 216. For example, the models can be regenerated on a periodic basis as new human physical characteristics or bio information is available to help keep the predictions in the model more accurate as the information evolves over time.

Some non-limiting examples of machine learning algorithms that can be used to generate and update the parameter functions or prediction models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms. These machine learning algorithms may include any type of machine learning algorithm, including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of player interaction data may be analyzed to generate models.

The memory 210 may include a location monitoring component 218. The location monitoring component 218 can be configured to monitor the location of employees. In some cases, the computing devices 102 utilized by employees can equipped with a location tracking system, such as GPS module, and the location monitoring component 218 can periodically or continuously receive the location information of the computing devices. In alternative cases, the computing devices 102 are connected to one or more routers, and the computing devices 102 transmit a beacon signal with location information to the routers. The routers can transmit the location information to the location monitoring component 218. In some cases, the location monitoring component 218 can set up a geographic boundary (e.g., virtual boundary), such as the geofence. For example, a patrol service provider can set up the geographic boundary for each security patrol area or each post of the patrol area. In this example, when a computing device 102 enters the boundary, the location monitoring component 218 can automatically identify the computing devices 102 information, such as the corresponding patrol officer's location information.

The memory 210 can further include an input processing component 220. The input processing component 220 can be configured to analyze input data received from the computing devices 102 and the sensors 120.

In some embodiments, the input processing component 220 can receive inputs from computing devices 102. In some examples, the input processing component 220 can receive images (and video clips) that capture the patrol officers' surrounding area. For instance, the patrol officer may be required to periodically scan the surrounding area, either at specified time intervals or upon entering a new post. In addition, the patrol officer can continuously capture images and transmit the captured images to the workflow monitoring service 114 via the network 104. Furthermore, the patrol officer can provide any information, such as incidents, in the form of text, voice, etc.

In various embodiments, the input processing component 220 can receive inputs from the sensors 120. Various types of sensors can be deployed in the workspace, such that, in non-limiting examples, temperature sensors, proximity sensors, light sensors, motion sensors, gas sensors, image sensors, radar sensors, etc., can be deployed for a security patrol service provider.

The input processing component 220 can continuously process inputs and identify any abnormalities. These abnormalities can be defined based on specific applications. For instance, in the context of a security patrol service provider, abnormalities could include the detection of unexpected movements, noise levels exceeding a certain threshold, temperatures (and/or humidity) surpassing a set limit, identification of an object resembling a weapon, detection of unknown individuals, and so forth. In some embodiments, the input processing component 220 can utilize the machine learned component 216 to detect the abnormalities by analyzing the input data received from the computing devices 102 and the sensors 120. For example, the input processing component 220 (e.g., by utilizing the machine learning component 216) can analyze the captured images by utilizing various types of image processing techniques, such as by identifying a region of interest from the captured image associated with one or more objects within the image. For example, the input processing component 220 can analyze image data associated with security patrol areas by detecting objects in the areas and analyzing whether these objects are risk objects. For example, the input processing component 220 may score risk score for each detected object. Additionally, the input processing component 220 may further verify its risk score by generating confidence values. In some embodiments, the machine learning component 216 can be continuously trained based on threshold confidence of example outputs corresponding to the trained model being used to identify the abnormalities within the workspace areas. For example, the training can be based on the ground truth level.

In some embodiments, the input processing component 220 can analyze the input data by vectorizing the space, such as the targeted patrol areas. For example, the input processing component 220 can vectorize a targeted patrol building and identify the location and area of the post from the vector. For example, a security patrol contract may specify the post area; for example, every 100 square feet of the patrol area needs one patrol official during a certain time. In these examples, the input processing component 220 can vectorize the patrol area, and this vectorized area can be utilized to determine the corresponding post area, such as the 100 square feet. Furthermore, the input processing component 220 can identify the number of post areas based on the vectorized targeted patrol area.

The memory 210 can also include an instruction generating component 222. In some embodiments, the instruction generating component 222 can provide work related instruction identified based on a master plan. For example, the master plan of a security patrol service provider can be provided as the hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflow for each level of the hierarchical data structure. For example, at the highest level, the master plan may include assigned attributes of the types of patrol areas, required security level, patrol time, etc. In the lowest level of the hierarchical data, such as posts, each post can be associated with the required patrol attributes for each post, such as the number of patrol officials, patrol time, required capability of the patrol official, and the like. In these embodiments, the instruction can be generated based on the workflow assigned to each post. In some examples, the instruction is provided in accordance with the shift schedule of patrol officers. For example, within a threshold time period before initiating the patrol, the instruction can be provided to the patrol officers. In some examples, this instruction can be provided to the patrol officer when the officer enters a post.

In some embodiments, the instruction can be generated based on the input analyzed results obtained from the input processing component 220. In various examples, the instruction generating component 222 can dynamically generate instructions based on the captured images and/or information received from each employee (e.g., each employee's computing device). The instructions are dynamically generated based on processing results of sensor data and inputs (e.g., captured images and incident report information) received from the computing devices 102. In addition, the instruction generating component 222 can generate the instructions based on the level of experience (or hierarchy) of employees. For example, the patrol officers within a post can receive different types of instructions based on each officer's level of experience. For instance, if the patrol officer is a junior officer, the instruction could be “contact a supervisor and report the incident.” If the patrol officer is a senior officer, the instruction could be “go to the incident area and secure the area.” In addition, if the patrol officer is a supervisor, the instruction could be “send two senior officers to the incident area.” In addition, the workflow monitoring service can generate the instructions based on the types of the incidents. For example, if the incident is related to a weapon found on a floor, the instruction could be “do not touch the found gun, secure the area, and call law enforcement.” Thus, the workflow monitoring service can generate instruction in dynamically changing environments. In some examples, the instructions are dynamically provided by associating with the vector representation identified by the input processing component 220. In some embodiments, the instruction generating component 222 can utilize the machine learning component 216 to generate the dynamic instructions.

In some embodiments, the workflow monitoring service 114, upon generating the instruction from the instruction generating component 22, can provide notification to various entities, such as business operation administrators, managing officers, on-duty employees, and the like. In some examples, the workflow monitoring service 114 can automatically determine and apply one or more corrective actions in addition to providing notifications. These entities can be connected with the workflow monitoring service 114 via the network interface 204 of the workflow monitoring service 114. For example, in the context of the network service provider used for a security patrol service, the workflow monitoring service 114 may detect abnormalities in certain patrol areas by obtaining and analyzing the sensors. In this example, the workflow monitoring service 114 may automatically notify the on-duty patrol officer(s), their supervisors, managing officers, a property owner of the security patrol areas, and the like. Additionally, the network service provider automatically identifies and applies correct actions. For example, if the workflow monitoring service 114 determines high temperature by receiving data from a temperature sensor, the workflow monitoring service 114 may automatically enable a sprinkler and/or contact the fire department. In some cases, the workflow monitoring service 114 may determine whether any action was taken regarding the detected abnormalities. For example, if the workflow monitoring service 114 detects a high temperature in a patrol area and no action is taken, the workflow monitoring service 114 may notify the managing officer(s), headquarters personnel of the security service provider, and the like. One skilled in the relevant will appreciate that additional or alternative notifications could be include and that any discussed notifications should not be limiting.

The memory 210 can also include an instruction verification component 224. The instruction verification component 224 can be configured to verify whether the generated instruction is confident. For example, if an instruction is generated, such as “secure a lobby because a gun is found at the lobby,” the patrol officer can verify this information. For instance, the patrol officer can go to the lobby and verify whether the gun is located in the lobby. During the verification, the patrol officer can provide a verification input. For example, if a gun is found at the lobby, the input could be a confirmation input. However, if the patrol officer could not find a gun, instead found a cardboard with a similar shape to the gun, the patrol officer can provide additional input, such as with the image of the cardboard and/or any description. In various examples, these additional inputs can be utilized as ground truth data to retrain the machine learning component 216.

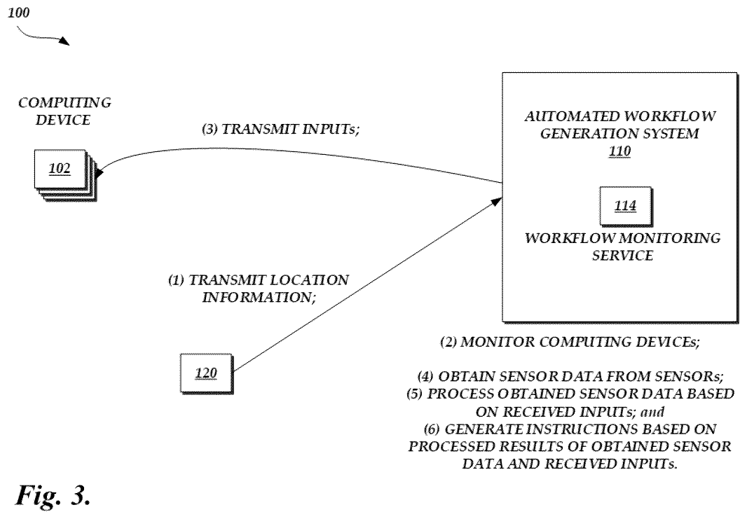

Turning now to FIG. 3, illustrative interactions of the components of the system 100, as shown in FIG. 1, will be described. For purposes of the illustration, it can be assumed that the network service provider 110 has been configured in a manner that implements the workflow monitoring service 114. For the purpose of description, FIG. 3 can be described with respect to a security patrol service provider. The present application is not intended to be limited to any particular type of service or the number of individual services that may be accessed or generate processing results as part of the execution of an application.

With reference to FIG. 3, an illustrative interaction of generating processing results that can be utilized in the aspects of workflow monitoring service and/or generating instructions will be described. The interaction is illustrative.

At (1), the computing devices 102 transmit location information to the workflow monitoring service 114. In some cases, the computing devices 102 utilized by employees can equipped with a location tracking system, such as GPS module. In alternative cases, the computing devices 102 are connected to one or more routers, and the computing devices 102 transmit a beacon signal with location information to the routers. The routers can transmit the location information to the location monitoring component 218.

At (2), the workflow monitoring service 114 monitors the location of computing devices 102. The workflow monitoring service 114 can periodically or continuously receive the location information of the computing devices 102. In some cases, the location monitoring component 218 can set up a geographic boundary (e.g., virtual boundary), such as the geofence. For example, a patrol service provider can set up the geographic boundary for each security patrol area or each post of the patrol area. In this example, when a computing device 102 (or set of computing devices) enters the boundary, the workflow monitoring service 114 can automatically identify the computing devices 102 information, such as the corresponding patrol officer's location information.

At (3), the computing devices 102 transmit inputs to the workflow monitoring service 114. In some examples, the workflow monitoring service 114 can receive images (and video clips) that capture the patrol officers' surrounding area. For instance, the patrol officer may be required to periodically scan the surrounding area, either at specified time intervals or upon entering a new post. In addition, the patrol officer can continuously capture images and transmit the captured images to the workflow monitoring service 114 via the network 104. Furthermore, the patrol officer can provide any information, such as incidents, in the form of text, voice, etc.

At (4), the workflow monitoring service 114 receives sensor data from the sensors 120. Various types of sensors can be deployed at the workspace, such that, in non-limiting examples, temperature sensors, proximity sensors, light sensors, motion sensors, gas sensors, image sensors, radar sensors, etc., can be deployed for a security patrol service provider.

At (5), the workflow monitoring service 114 processes the received inputs and sensor data. In some embodiments, the workflow monitoring service 114 can continuously process inputs and identify any abnormalities. These abnormalities can be defined based on specific applications. For instance, in the context of a security patrol service provider, abnormalities could include the detection of unexpected movements, noise levels exceeding a certain threshold, temperatures (and/or humidity) surpassing a set limit, identification of an object resembling a weapon, detection of unknown individuals, and so forth. In some embodiments, the workflow monitoring service 114 can utilize the machine learned component 216 (shown in FIG. 2) to detect the abnormalities by analyzing the input data received from the computing devices 102 and the sensors 120. For example, the workflow monitoring service 114 (e.g., by utilizing the machine learning component 216) can analyze the captured images by utilizing various types of image processing techniques, such as by identifying a region of interest from the captured image associated with one or more objects within the image. For example, the workflow monitoring service 114 can analyze image data associated with security patrol areas by detecting objects in the areas and analyzing whether these objects are risk objects. For example, the workflow monitoring service 114 may score risk score for each detected object. Additionally, the workflow monitoring service 114 may further verify its risk score by generating confidence values. In some embodiments, the machine learning component 216 can be continuously trained based on threshold confidence of example outputs corresponding to the trained model being used to identify the abnormalities within the workspace areas. For example, the training can be based on the ground truth level.

In some embodiments, the workflow monitoring service 114 can analyze the input data (and the sensor data) by vectorizing the space, such as the targeted patrol areas. For example, the workflow monitoring service 114 can vectorize a targeted patrol building and identify the location and area of the post from the vector. In some examples, a security patrol contract may specify the post area, such as every 100 square feet of the patrol area needs one patrol official during a certain time. In these examples, the workflow monitoring service 114 can vectorize the patrol area, and this vectorized area can be utilized to determine the corresponding post area, such as the 100 square feet. Furthermore, the workflow monitoring service 114 can identify the number of post areas based on the vectorized targeted patrol area.

At (6), the workflow monitoring service 114 generates instructions. In some embodiments, the workflow monitoring service 114 can provide work related instruction identified based on a master plan. For example, the master plan of a security patrol service provider can be provided as hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflow for each level of the hierarchical data structure. For example, at the highest level, the master plan may include assigned attributes of the types of patrol areas, required security level, patrol time, etc. In the lost level of the hierarchical data, such as posts, each post can be associated with the required patrol attributes for each post, such as the number of patrol officials, patrol time, required capability of the patrol official, and the like. In these embodiments, the instruction can be generated based on the workflow assigned to each post. In some examples, the instruction is provided in accordance with shift schedule of patrol officers. For example, within a threshold time period before initiating the patrol, the instruction can be provided to the patrol officers. In some examples, this instruction can be provided to the patrol officer when the officer enters a post.

In some embodiments, the instruction can be generated based on the input analyzed results obtained at (5). In various examples, the workflow monitoring service 114 can dynamically generate instructions based on the captured images and/or information received from each employee (e.g., each employee's computing device). The instructions are dynamically generated based on processing results of sensor data and inputs (e.g., captured images and incident report information) received from the computing devices 102. In addition, the workflow monitoring service 114 can generate the instructions based on the level of experience (or hierarchy) of employees. For example, the patrol officers within a post can receive different types of instructions based on each officer's level of experience. For instance, if the patrol officer is a junior officer, the instruction could be “contact a supervisor and report the incident.” If the patrol officer is a senior officer, the instruction could be “go to the incident area and secure the area.” In addition, if the patrol officer is a supervisor, the instruction could be “send two senior officers to the incident area.” In addition, the workflow monitoring service can generate instructions based on the types of the incidents. For example, if the incident is related to a weapon found on a floor, the instruction could be “do not touch the found gun, secure the area, and call law enforcement.” Thus, the workflow monitoring service can generate instruction in dynamically changing environments. In some examples, the instructions are dynamically provided by associating with the vector representation identified by the workflow monitoring service 114. In some embodiments, the workflow monitoring service 114 can utilize the machine learning component 216 to generate the dynamic instructions. At step (7), the workflow monitoring service 114 can send instructions to the computing devices. These instructions can be transmitted in real time when the workflow monitoring service 114 detects any abnormalities from the received inputs and sensor data. These instructions can also be sent to the computing devices 102 situated near the location where the abnormalities were detected.

Illustratively, the workflow monitoring service 114 can provide the instructions to various entities, such as business operation administrators, managing officers, on-duty employees, and the like. In some examples, the workflow monitoring service 114 can automatically determine and apply one or more corrective actions in addition to providing notifications. These entities can be connected with the workflow monitoring service 114 via the network interface 204 of the workflow monitoring service 114. For example, in the context of the network service provider used for a security patrol service, the workflow monitoring service 114 may detect abnormalities in certain patrol areas by obtaining and analyzing the sensors. In this example, the workflow monitoring service 114 may automatically notify the on-duty patrol officer(s), their supervisors, managing officers, a property owner of the security patrol areas, and the like. Additionally, the network service provider automatically identifies and applies correct actions. For example, if the workflow monitoring service 114 determines high temperature by receiving data from a temperature sensor, the workflow monitoring service 114 may automatically enable a sprinkler and/or contact the fire department. In some cases, the workflow monitoring service 114 may determine whether any action was taken regarding the detected abnormalities. For example, if the workflow monitoring service 114 detects a high temperature in a patrol area and no action is taken, the workflow monitoring service 114 may notify the managing officer(s), headquarters personnel of the security service provider, and the like. The present disclosure does not limit the types of notifications.

In some embodiments, the workflow monitoring service 114 can verify the generated instructions. The workflow monitoring service 114 can be configured to verify whether the generated instruction is confident. For example, if an instruction is generated, such as “secure a lobby because a gun is found at the lobby,” the patrol officer can verify this information. For instance, the patrol officer can go to the lobby and verify whether the gun is located in the lobby. During the verification, the patrol officer can provide a verification input. For example, if a gun is found in the lobby, the input could be a confirmation input. However, if the patrol officer could not find a gun and instead found a cardboard with a similar shape to the gun, the patrol officer could provide additional input, such as the image of the cardboard and/or any description. In various examples, these additional inputs can be utilized as ground truth data to retrain the machine learning component 216. For example, the machine learning algorithms of the machine learning component 216 can be configured to adaptively develop and update the models over time based on new input received by the machine learning component 216. For example, the models can be regenerated on a periodic basis as new object characteristics and human physical characteristic or bio information are available to help keep the predictions in the model more accurate as the information evolves over time. In some embodiments, these objects' characteristics and human physical characteristics or bio information can be stored in the database 150. In these embodiments, the machine learning algorithms trained with these characteristics can also be stored in the database 150.

Although the interactions illustrated in FIG. 3 are described in a particular order, it should be understood that these interactions are not limited as such. The interactions may be performed in an alternative order, serially, or at least partially in parallel. For example, interactions associated with (3) and (4) may be performed in parallel.

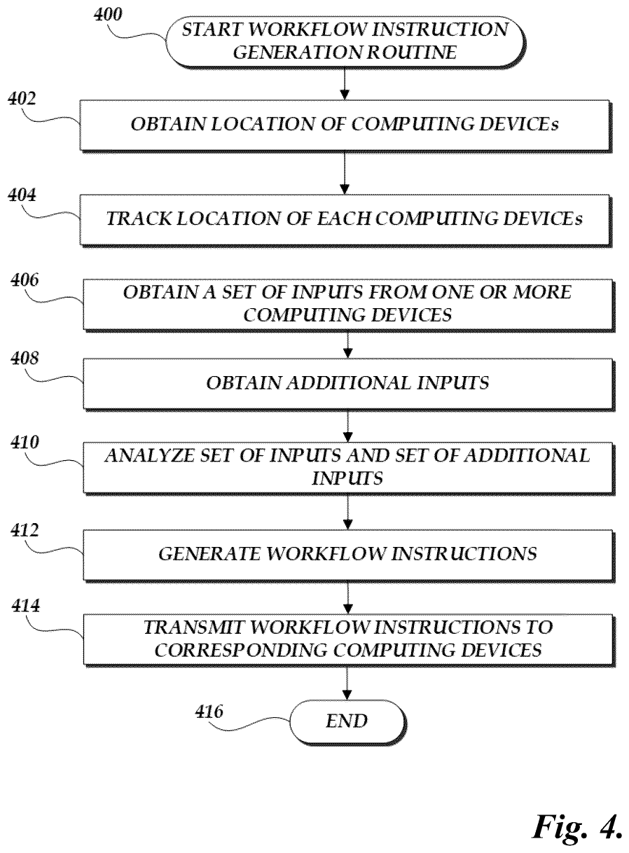

Turning now to FIG. 4, a workflow instruction generation routine 400 based on various aspects, as disclosed in the present disclosure, will be described. For the purpose of illustration, the routine 400 can be performed by the workflow monitoring service 114 implemented in the network service provider 110.

At block 402, the workflow monitoring service 114 obtains a set of location information from a plurality of computing devices. In some examples, the set of location information includes geometry identifiers and time identifiers of each of the plurality of computing devices. For illustrations, the computing devices 102 transmit location information to the workflow monitoring service 114. In some cases, the computing devices 102 utilized by employees can equipped with a location tracking system, such as GPS module. In alternative cases, the computing devices 102 are connected to one or more routers, and the computing devices 102 transmit a beacon signal with location information to the routers. The routers can transmit the location information to the location monitoring component 218.

At block 404, the workflow monitoring service 114 tracks the location of computing devices 102. In some examples, the workflow monitoring service 114 tracks locations of the plurality of computing devices by analyzing the set of location information within targeted areas, for example, the targeted areas include a plurality of sub-areas. In some examples, each sub-area is vectorized and stored in the memory 210. The workflow monitoring service 114 can periodically or continuously receive the location information of the computing devices 102. In some cases, the location monitoring component 218 can set up a geographic boundary (e.g., virtual boundary), such as the geofence. For example, a patrol service provider can set up the geographic boundary for each security patrol area or each post of the patrol area. In this example, when computing devices 102 enter the boundary, the workflow monitoring service 114 can automatically identify the computing devices 102 information, such as the corresponding patrol officer's location information.

At block 406, the workflow monitoring service 114 obtains a set of inputs from the computing devices 102. In some examples, the workflow monitoring service 114 can receive images (and video clips) that capture the surrounding area of the patrol officers. For instance, the patrol officer may be required to periodically scan the surrounding area, either at specified time intervals or upon entering a new post. In addition, the patrol officer can continuously capture images and transmit the captured images to the workflow monitoring service 114 via the network 104. Furthermore, the patrol officer can provide any information, such as incidents, in the form of text, voice, etc.

At block 408, the workflow monitoring service 114 obtains a set of additional inputs from a plurality of sensors 120 deployed in the targeted areas. Various types of sensors can be deployed in the workspace, such that, in non-limiting examples, temperature sensors, proximity sensors, light sensors, motion sensors, gas sensors, image sensors, radar sensors, etc., can be deployed for a security patrol service provider.

At block 410, the workflow monitoring service 114 analyzes the obtained set of inputs and set of additional inputs. In some embodiments, the workflow monitoring service 114 analyzes these inputs by utilizing a machine learning component 216 stored in the memory 210. In some examples, the workflow monitoring service 114 analyzes the set of inputs and the set of additional inputs to determine risk scores associated with the targeted areas such that results of the analysis indicate risk scores of sub-areas associated with the set of inputs. In some embodiments, the machine learning component 216 can include a neural network model trained to generate the risk scores of the sub-areas. In some examples, the neural network model is configured to collect, from a historical data stored in a database, a set of previous inputs, a set of previous additional inputs, and risk scores associated with the set of previous inputs and additional inputs, apply the set of previous inputs and the set of previous additional inputs to the neural network model, generate a set of risk scores associated with corresponding sub-areas associated with the set of previous inputs and the set of previous additional inputs, train the neural network model by verifying the generated set of risk scores with the risk scores associated with the set of previous inputs and additional inputs, and determine the risk scores by using the trained neural network model.

In some cases, the workflow monitoring service 114 can determine, for each sub-area associated with the set of inputs, whether the risk score is at or above a threshold risk score.

In some embodiments, the workflow monitoring service 114 processes the received inputs and sensor data. In some embodiments, the workflow monitoring service 114 can continuously process inputs and identify any abnormalities. These abnormalities can be defined based on specific applications. For instance, in the context of a security patrol service provider, abnormalities could include the detection of unexpected movements, noise levels exceeding a certain threshold, temperatures (and/or humidity) surpassing a set limit, identification of an object resembling a weapon, detection of unknown individuals, and so forth. In some embodiments, the workflow monitoring service 114 can utilize the machine learned component 216 (shown in FIG. 2) to detect the abnormalities by analyzing the input data received from the computing devices 102 and the sensors 120. For example, the workflow monitoring service 114 (e.g., by utilizing the machine learning component 216) can analyze the captured images by utilizing various types of image processing techniques, such as by identifying a region of interest from the captured image associated with one or more objects within the image. For example, the workflow monitoring service 114 can analyze image data associated with security patrol areas by detecting objects in the areas and analyzing whether these objects are risk objects. For example, the workflow monitoring service 114 may score risk score for each detected object. Additionally, the workflow monitoring service 114 may further verify its risk score by generating confidence values. In some embodiments, the machine learning component 216 can be continuously trained based on threshold confidence of example outputs corresponding to the trained model being used to identify the abnormalities within the workspace areas. For example, the training can be based on the ground truth level.

In some embodiments, the workflow monitoring service 114 can analyze the input data (and the sensor data) by vectorizing the space, such as the targeted patrol areas. For example, the workflow monitoring service 114 can vectorize a targeted patrol building and identify the location and area of the post from the vector. In some examples, a security patrol contract may specify the post area, such as every 100 square feet of the patrol area needs one patrol official during a certain time. In these examples, the workflow monitoring service 114 can vectorize the patrol area, and this vectorized area can be utilized to determine the corresponding post area, such as the 100 square feet. In some embodiments, the workflow monitoring service 114 determines risk score for each attribute of the sensor data. For example, if an attribute of noise sensor, such as a noise level, is above a threshold, the workflow monitoring service 114 may analyze it as a high risk score. Furthermore, the workflow monitoring service 114 can identify the number of post areas based on the vectorized targeted patrol area.

At block 412, the workflow monitoring service 114 generates workflow instructions such that the workflow monitoring service 114 generates, for each vectorized sub-area having the risk score at or above the threshold risk score, workflow instructions. For example, implementing the workflow instructions can mitigate risks of the vectorized sub-areas, having the risk score at or above the threshold risk score. In some examples, the workflow instructions include a set of hierarchical data, and the hierarchical data include a plurality of layers, where each layer associated with one or more instructions to be performed by one or more employees associated with the one or more computing devices located in proximity to the vectorized sub-areas, having the risk score at or above the threshold risk score. In some cases, the one or more instructions are patrolling a patrol area, where a top level of the hierarchical data is a master plan for patrolling the patrol area, having a plurality of posts, and a lower level of the hierarchical data is a patrolling plan of each post of the plurality of posts.

In some examples, the neural network model stored in the machine learning component 216 can dynamically generate the workflow instructions by collecting, from the historical data stored in the database, the set of previous inputs, the set of previous additional inputs, and a set of historical risk scores associated with the set of previous inputs and the set of previous additional inputs, applying the set of previous inputs and the set of previous additional inputs to the neural network model, and generating a set of workflow instructions associated with corresponding vectorized sub-areas associated with the set of previous inputs and the set of previous additional inputs. In various examples, wherein the neural network model is further configured to create a training set by comparing the generated set of set of workflow instructions with a historical set of workflow instructions stored in the database, where the historical set of workflow instructions is associated with the set of previous inputs and the set of previous additional inputs. In some examples, the machine learning component 216 is further configured to dynamically generate the workflow instructions by dynamically receiving the set of additional data. Furthermore, the machine learning component 216 can be configured to generate a plurality of workflow instructions by modifying one or more sensor data of the set of additional inputs, applying the modified one or more sensor data to the neural network model, and generating the plurality of workflow instructions based on the modified one or more sensor data. In some cases, the machine learning component 216 can be configured to train the neural network model by updating neural network parameters by comparing the generated set of risk scores and historical set of risk scores stored in the database, the historical set of risk scores associated with the set of previous inputs and the set of previous additional inputs.

In some embodiments, the workflow monitoring service 114 can provide work related instruction identified based on a master plan. For example, the master plan of a security patrol service provider can be provided as hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflow for each level of the hierarchical data structure. For example, at the highest level, the master plan may include assigned attributes of the types of patrol areas, required security level, patrol time, etc. In the lost level of the hierarchical data, such as posts, each post can be associated with the required patrol attributes for each post, such as the number of patrol officials, patrol time, required capability of the patrol official, and the like. In these embodiments, the instruction can be generated based on the workflow assigned to each post. In some examples, the instruction is provided in accordance with the shift schedule of patrol officers. For example, within a threshold time period before initiating the patrol, the instruction can be provided to the patrol officers. In some examples, this instruction can be provided to the patrol officer when the officer enters a post.

In some embodiments, the instruction can be generated based on the input analyzed results obtained at block 410. In various examples, the workflow monitoring service 114 can dynamically generate instructions based on the captured images and/or information received from each employee (e.g., each employee's computing device). The instructions are dynamically generated based on processing results of sensor data and inputs (e.g., captured images and incident report information) received from the computing devices 102. In addition, the workflow monitoring service 114 can generate the instructions based on the level of experience (or hierarchy) of employees. For example, the patrol officers within a post can receive different types of instructions based on each officer's level of experience. For instance, if the patrol officer is a junior officer, the instruction could be “contact a supervisor and report the incident.” If the patrol officer is a senior officer, the instruction could be “go to the incident area and secure the area.” In addition, if the patrol officer is a supervisor, the instruction could be “send two senior officers to the incident area.” In addition, the workflow monitoring service can generate the instructions based on the types of the incidents. For example, if the incident is related to a weapon found on a floor, the instruction could be “do not touch the found gun, secure the area, and call law enforcement.” Thus, the workflow monitoring service can generate instruction in dynamically changing environments. In some examples, the instructions are dynamically provided by associating with the vector representation identified by the workflow monitoring service 114. In some embodiments, the workflow monitoring service 114 can utilize the machine learning component 216 to generate the dynamic instructions.

At block 414, the workflow monitoring service 114 transmits instructions to the computing devices. These instructions can be transmitted in real time when the workflow monitoring service 114 detects any abnormalities from the received inputs and sensor data. These instructions can also be sent to the computing devices 102 situated near the location where the abnormalities were detected.

In some embodiments, the workflow monitoring service 114 can verify the generated instructions. The workflow monitoring service 114 can be configured to verify whether the generated instruction is confident. For example, if an instruction is generated, such as “secure a lobby because a gun is found at the lobby,” the patrol officer can verify this information. For instance, the patrol officer can go to the lobby and verify whether the gun is located in the lobby. During the verification, the patrol officer can provide a verification input. For example, if a gun is found at the lobby, the input could be a confirmation input. However, if the patrol officer could not find a gun, instead found a cardboard with a similar shape of the gun, the patrol officer can provide additional input, such as with the image of the cardboard and/or any description. In various examples, these additional inputs can be utilized as ground truth data to retrain the machine learning component 216. For example, the machine learning algorithms of the machine learning component 216 can be configured to adaptively develop and update the models over time based on new input received by the machine learning component 216. For example, the models can be regenerated on a periodic basis as new object characteristics and human physical characteristics or bio information is available to help keep the predictions in the model more accurate as the information evolves over time. In some embodiments, these objects characteristics and human physical characteristics or bio information can be stored in the database 150. In these embodiments, the machine learning algorithms trained with these characteristics can also be stored in the database 150. The routine 400 is ended at block 416.

In some cases, the workflow monitoring service 114 can provide the instructions to various entities, such as business operation administrators, managing officers, on-duty employees, and the like. These entities can be connected with the workflow monitoring service 114 via the network 104 or 106. For example, in the context of the network service provider used for a security patrol service, the workflow monitoring service 114 may detect abnormalities in certain patrol areas by obtaining and analyzing the sensors. In this example, the workflow monitoring service 114 may automatically notify the on-duty patrol officer(s), their supervisors, managing officers, a property owner of the security patrol areas, and the like. In some cases, the workflow monitoring service 114 may determine whether any action was taken regarding the detected abnormalities. For example, if the workflow monitoring service 114 detects a high temperature in a patrol area and that no action was taken, the workflow monitoring service 114 may notify to the managing officer(s), headquarters personal of the security service provider, and the like. The present disclosure does not limit the types of notifications.

Although the operations of the routine 400 are described in a particular order, it should be understood that the routine 400 is not limited as such. Operations of the routine 400 may be performed in an alternative order, serially, or at least partially in parallel. Further, certain operations may not need to be performed. For example, operations associated with the block 406 and block 408 may be performed in parallel.

Although the operations of the routine 400 are described in a particular order, it should be understood that the routine 400 is not limited as such. Operations of the routine 400 may be performed in an alternative order, serially, or at least partially in parallel. Further, certain operations may not need to be performed.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed:

1. A system for dynamically providing workflow instructions in network-based services, the system comprising:
one or more computing devices associated with a processor and a memory for executing computer-executable instructions to implement a workflow monitoring service, wherein the workflow monitoring service is configured to:
obtain a set of location information from a plurality of computing devices, wherein the set of location information comprises geometry identifiers and time identifiers of each of the plurality of computing devices;
track locations of the plurality of computing devices by analyzing the set of location information within targeted areas, wherein the targeted areas include a plurality of sub-areas, and wherein each sub-area is vectorized and stored in the memory;
obtain a set of inputs from one or more of the plurality of computing devices located in the targeted areas, wherein the set of inputs comprises one or more captured images captured in one of the sub-areas;
obtain a set of additional inputs from a plurality of sensors deployed in the targeted areas;
analyze, by utilizing a machine learning component stored in the memory, the set of inputs and the set of additional inputs to determine risk scores associated with the targeted areas, wherein results of the analysis indicate risk scores of sub-areas associated with the set of inputs, wherein the machine learning component comprises a neural network model trained to generate the risk scores of the sub-areas, the neural network model is configured to:
collect, from a historical data stored in a database, a set of previous inputs, a set of previous additional inputs, and risk scores associated with the set of previous inputs and additional inputs,
apply the set of previous inputs and the set of previous additional inputs to the neural network model,
generate a set of risk scores associated with corresponding sub-areas associated with the set of previous inputs and the set of previous additional inputs,
train the neural network model by verifying the generated set of risk scores with the risk scores associated with the set of previous inputs and additional inputs, and
determine the risk scores by using the trained neural network model;
determine, for each sub-area associated with the set of inputs, whether the risk score is at or above a threshold risk score;
generate, for each vectorized sub-area having the risk score at or above the threshold risk score, workflow instructions, the workflow instructions configured to mitigate risks of the vectorized sub-areas, having the risk score at or above the threshold risk score; and
transmit the generated workflow instructions to one or more computing devices located in proximity to the vectorized sub-areas, having the risk score at or above the threshold risk score, wherein the one or more computing devices are identified based on the obtained set of location information.

2. The system of claim 1, wherein the workflow instructions comprise a set of hierarchical data, the hierarchical data comprising a plurality of layers, each layer associated with one or more instructions to be performed by one or more employees associated with the one or more computing devices located in proximity to the vectorized sub-areas, having the risk score at or above the threshold risk score.

3. The system of claim 2, wherein the one or more instructions are patrolling a patrol area, wherein a top level of the hierarchical data is a master plan for patrolling the patrol area, having a plurality of posts, wherein a lower level of the hierarchical data is a patrolling plan of each post of the plurality of posts.

4. The system of claim 1, wherein the neural network model is further configured to dynamically generate the workflow instructions by:
collecting, from the historical data stored in the database, the set of previous inputs, the set of previous additional inputs, and a set of historical risk scores associated with the set of previous inputs and the set of previous additional inputs,
applying the set of previous inputs and the set of previous additional inputs to the neural network model, and
generating a set of workflow instructions associated with corresponding vectorized sub-areas associated with the set of previous inputs and the set of previous additional inputs.

5. The system of claim 4, wherein the neural network model is further configured to create a training set by comparing the generated set of set of workflow instructions with a historical set of workflow instructions stored in the database, the historical set of workflow instructions associated with the set of previous inputs and the set of previous additional inputs.

6. The system of claim 4, wherein the machine learning component is further configured to dynamically generate the workflow instructions by dynamically receiving the set of additional data.

7. The system of claim 4, wherein the machine learning component is configured to generate a plurality of workflow instructions by modifying one or more sensor data of the set of additional inputs, applying the modified one or more sensor data to the neural network model, and generating the plurality of workflow instructions based on the modified one or more sensor data.

8. The system of claim 1, wherein the machine learning component is configured to train the neural network model by updating neural network parameters by comparing the generated set of risk scores and historical set of risk scores stored in the database, the historical set of risk scores associated with the set of previous inputs and the set of previous additional inputs.

9. The system of claim 1, wherein the plurality of sensors comprises temperature sensors, object detection sensors, gas sensors, image sensors, and radar sensors.

10. The system of claim 1, wherein the workflow monitoring service is further configured to authenticate the computing device by receiving an application program interface token from the plurality of computing devices and verifying the received application program interface token.

11. The system of claim 1, wherein the neural network model is further configured to determine the risk scores by identifying objects detected in the set of inputs.

12. A system for dynamically providing workflow instructions in network-based services, the system comprising:
one or more computing devices associated with a processor and a memory for executing computer-executable instructions to implement a workflow monitoring service, wherein the workflow monitoring service is configured to:
obtain a set of inputs from a plurality of computing devices located in targeted areas,
the targeted areas, including a plurality of sub-areas,
each sub-area being vectorized, and
the set of inputs comprising one or more captured images captured in one of the vectorized sub-areas;
obtain a set of additional inputs from a plurality of sensors deployed in the targeted areas;
analyze, by utilizing a machine learning component stored in the memory, the set of inputs and the set of additional inputs to determine risk scores associated with the targeted areas, wherein results of the analysis indicate risk scores of sub-areas associated with the set of inputs, wherein the machine learning component comprises a neural network model configured to:
collect, from a historical data stored in a database, a set of previous inputs and a set of previous additional inputs,
apply the set of previous inputs and the set of previous additional inputs to the neural network model, and
generate a set of risk scores associated with corresponding sub-areas associated with the set of previous inputs and the set of previous additional inputs,
determine, for each sub-area associated with the set of inputs, whether the risk score is at or above a threshold risk score; and
generate, for each vectorized sub-area having the risk score at or above the threshold risk score, workflow instructions, the workflow instructions configured to mitigate risks of the vectorized sub-areas, having the risk score at or above the threshold risk score.

13. The system of claim 12, wherein the workflow instructions comprise a set of hierarchical data, the hierarchical data comprising a plurality of layers, each layer associated with one or more instructions to be performed by one or more employees associated with the one or more computing devices located in proximity to the vectorized sub-areas, having the risk score at or above the threshold risk score.

14. The system of claim 13, wherein the one or more instructions are patrolling a patrol area, wherein a top level of the hierarchical data is a master plan for patrolling the patrol area, having a plurality of posts, wherein a lower level of the hierarchical data is a patrolling plan of each post of the plurality of posts.

15. The system of claim 12, wherein the neural network model is further configured to dynamically generate the workflow instructions by:
collecting, from the historical data stored in the database, the set of previous inputs, the set of previous additional inputs, and a set of historical risk scores associated with the set of previous inputs and the set of previous additional inputs,
applying the set of previous inputs and the set of previous additional inputs to the neural network model, and
generating a set of workflow instructions associated with corresponding vectorized sub-areas associated with the set of previous inputs and the set of previous additional inputs.

16. The system of claim 15, wherein the machine learning component is further configured to dynamically generate the workflow instructions by dynamically receiving the set of additional data.

17. The system of claim 4, wherein the machine learning component is configured to generate a plurality of workflow instructions by modifying one or more sensor data of the set of additional inputs, applying the modified one or more sensor data to the neural network model, and generating the plurality of workflow instructions based on the modified one or more sensor data.

18. The system of claim 12, wherein the machine learning component is configured to train the neural network model by updating neural network parameters by comparing the generated set of risk scores and historical set of risk scores stored in the database, the historical set of risk scores associated with the set of previous inputs and the set of previous additional inputs.

19. The system of claim 12, wherein the workflow monitoring service is further configured to transmit the generated workflow instructions to one or more computing devices located in the vectorized sub-areas, having the risk score at or above the threshold risk score.

20. A method for dynamically providing workflow instructions in network-based services, the method comprising:
obtaining a set of location information from a plurality of computing devices, wherein the set of location information comprises geometry identifiers and time identifiers of each of the plurality of computing devices;
tracking locations of the plurality of computing devices by analyzing the set of location information within targeted areas, wherein the targeted areas include a plurality of sub-areas, and wherein each sub-area is vectorized;
obtaining a set of inputs from one or more of the plurality of computing devices located in the targeted areas, wherein the set of inputs comprises one or more captured images captured in one of the sub-areas;
obtaining a set of additional inputs from a plurality of sensors deployed in the targeted areas;
analyzing, by utilizing a machine learning component, the set of inputs and the set of additional inputs to determine risk scores associated with the targeted areas, wherein results of the analysis indicate risk scores of sub-areas associated with the set of inputs, wherein the machine learning component comprises a neural network model configured to:
collect, from a historical data stored in a database, a set of previous inputs and a set of previous additional inputs,
apply the set of previous inputs and the set of previous additional inputs to the neural network model, and
generate a set of risk scores associated with corresponding sub-areas associated with the set of previous inputs and the set of previous additional inputs,
determining, for each sub-area associated with the set of inputs, whether the risk score is at or above a threshold risk score;
generating, for each vectorized sub-area having the risk score at or above the threshold risk score, workflow instructions, the workflow instructions configured to mitigate risks of the vectorized sub-areas, having the risk score at or above the threshold risk score; and
transmitting the generated workflow instructions to one or more computing devices located in proximity to the vectorized sub-areas, having the risk score at or above the threshold risk score, wherein the one or more computing devices are identified based on the obtained set of location information.
